(19) United States
(12) Patent Application Publication
(10) Pub. No.: US 2009/0169122 A1
(43) Pub. Date: Jul. 2, 2009

(54) METHOD AND APPARATUS FOR FOCUSING ON OBJECTS AT DIFFERENT DISTANCES FOR ONE IMAGE

(75) Inventors: Fan HE, Gurnee, IL (US); Michael Frenzer, Palatine, IL (US); Joy Xiong, Vernon Hills, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/965,025

(22) Filed: Dec. 27, 2007

(51) Int. Cl. G06K 9/36; G06K 9/40

(52) U.S. Cl. 382/238; 382/255

(57) ABSTRACT

A method (300) and apparatus (200) for focusing on images at different distances is disclosed. The method may include focusing on a first object at a first distance, capturing (320) a first image based on focusing on the first object at the first distance, focusing on a second object at a second distance, where the second distance is different from the first distance, and capturing (330) a second image based on focusing on the second object at the second distance. The method may also include compressing (340) the first image, compressing (350) the second image, and creating (360) a third image based on a combination of the compressed first image and the compressed second image.

### BACKGROUND

1. Field

The present disclosure is directed to devices that use digital cameras. More particularly, the present disclosure is directed to focusing on objects at different distances for one image.

2. Introduction

Presently, digital cameras are used by many people, from professionals to casual users. While professionals may deliberately make certain parts of a picture out of focus for a desired effect, casual users usually want to keep the entire picture in focus. Unfortunately, the entire picture may not be in focus when some objects are close in the near field and other objects are far in the far field. A good depth of field in a camera can achieve good focus on subjects in both far and near fields. However, many portable devices that include cameras are too small to use high depth of field lenses. For example, portable cellular phones are too small to include high depth of field lenses. The wave front modulation method can also be used to achieve better focus. Yet, that method is not optimal because it requires a special lens design and very tight tolerances, which is not suitable for mass production. Furthermore, the wave front modulation method is not optimal because it has about 3 dB SNR tradeoff.

Thus, there is a need for method and apparatus for focusing on objects at different distances for one image.

### SUMMARY

A method and apparatus for focusing on images at different distances for one image is disclosed. The method may include focusing on a first object at a first distance, capturing a first image based on focusing on the first object at the first distance, focusing on a second object at a second distance, where the second distance is different from the first distance, and capturing a second image based on focusing on the second object at the second distance. The method may also include compressing the first image, compressing the second image, and creating a third image based on a combination of the compressed first image and the compressed second image.

### BRIEF DESCRIPTION OF THE DRAWINGS

In order to describe the manner in which advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary a system in accordance with a possible embodiment;

FIG. 2 illustrates an exemplary block diagram of an apparatus in accordance with a possible embodiment;

FIG. 3 is an exemplary flowchart illustrating the operation of an apparatus in accordance with a possible embodiment;

FIG. 4 is an exemplary flowchart illustrating the operation of an apparatus in accordance with a possible embodiment;

FIG. 5 is an exemplary illustration of an array according to one possible embodiment; and

FIG. 6 is an exemplary illustration of an algorithm according to one possible embodiment.

### DETAILED DESCRIPTION

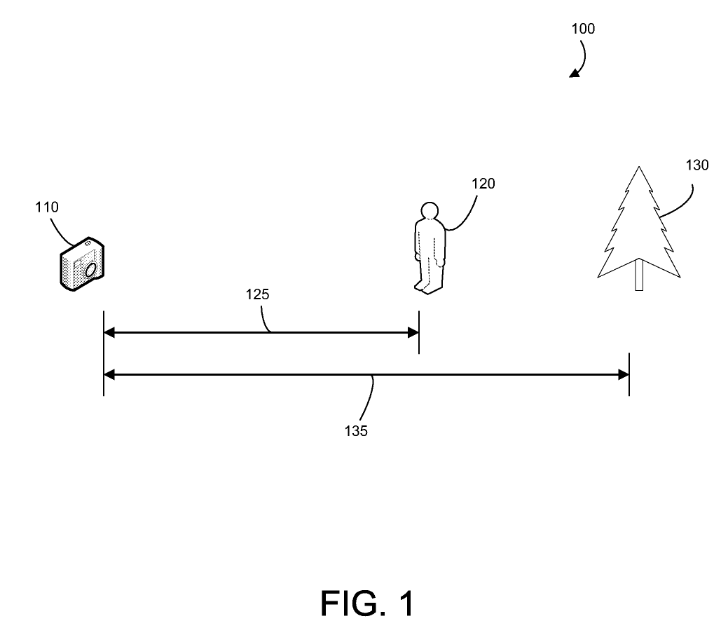

FIG. 1 is an exemplary illustration of a system 100 according to one possible embodiment. The system 100 can include an apparatus 110 including a digital camera, a first object 120 at a first distance 125, and a second object 130 at a second distance 135. The apparatus 110 may be a digital camera or any device than can include a digital camera, such as a wireless communication device, a wireless telephone, a cellular telephone, a personal digital assistant, a pager, a personal computer, a selective call receiver, or any other device that can use a digital camera.

In operation, the apparatus 110 can focus on the first object 120 at the first distance 125 and capture a first image based on focusing on the first object 120 at the first distance 125. The apparatus 110 can focus on the second object 130 at a second distance 135, where the second distance can be different from the first distance, and capture a second image based on focusing on the second object 130 at the second distance 135. The apparatus 110 can split the first image into first blocks including components and split the second image into second blocks including components. The apparatus 110 can then store the sum of the components of each of the first blocks into a first array and store the sum of the components of each of the second blocks into a second array. For example, the apparatus can store the sum of the components or the sum of the absolute value of the components. The apparatus 110 can then compare elements of the first array with elements of the second array and create a third image based on combining the blocks of the first image with the blocks of the second image based on comparing the elements of the first array with the elements of the second array.

For example, the apparatus 110 can combine two or more pictures focused in far and near fields. The apparatus 110 can then use band-pass filtering to determine a focus threshold from the far and near field pictures for the combined picture. This filtering can be done after performing a Discrete Cosine Transform (DTC) on each image. The apparatus 110 can then use a statistical method to determine the areas for focused image data from different images.

As a further example, a user can take two pictures of the same scene, such as separate far-field and near-field pictures. The taking of two pictures may be done sequentially in background operations of the apparatus 110 without user action. Processing can then be applied to the captured images. Each image can be split into many 8×8 pixel blocks. DCT can be applied on each block followed by a summation operation on the frequency spectrum. The blocks between the near and far fields can be compared, and those with high summation and corresponding good focus can be kept and later used as a substitute for less focused blocks in the other image to form a new image. Low pass filtering may then be applied to the reconstituted image, which now has less fuzzy and misfocused blocks. Thus, the good focus areas from two or more images can be combined into one image with good focus range. If the image processing is done in compressed space, it can require less memory and less computing time at a lower power consumption, which can make it useful in portable electronic devices and other devices.

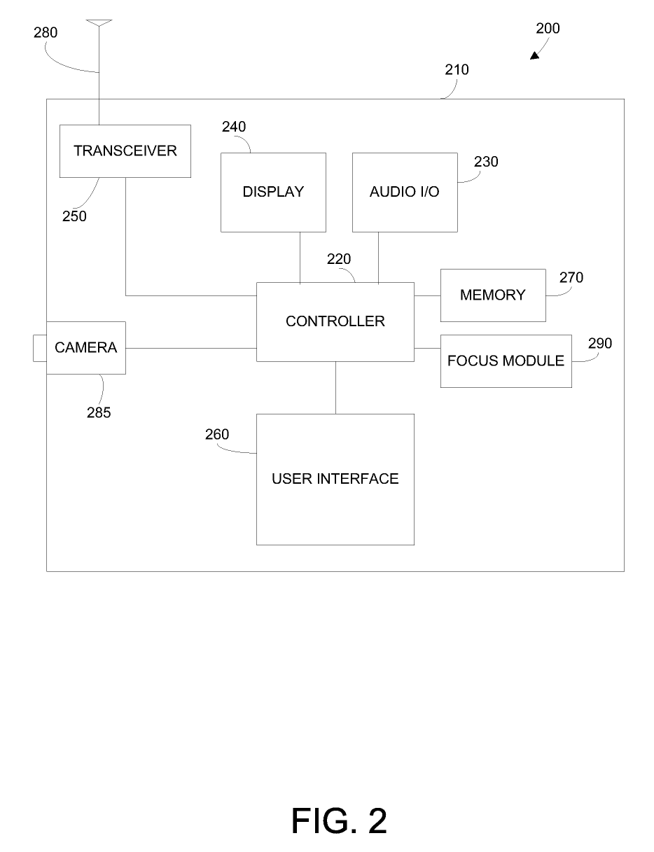

FIG. 2 is an exemplary block diagram of an apparatus 200, such as the apparatus 110, according to one possible embodiment. The apparatus 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a camera module 285. The apparatus 200 can also include a multiple image focus module 290. The multiple image focus module 290 can be coupled to the controller 220, can reside within the controller 220, can reside within the memory 270, can be an autonomous module, can be software, can be hardware, or can be in any other format useful for a module on a apparatus 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a device. The apparatus 200 further may not necessarily include all of the illustrated elements. For example, the apparatus 200 may or may not include the antenna 280, the transceiver 250, the audio input and output circuitry 230 or other elements depending on the desired functionality of the apparatus 200.

In operation, the controller 220 can control the operations of the apparatus 200. The camera module 285 can focus on an object at a first distance and capture a first image based on focusing on the object at the first distance. The camera module 285 can also focus on an object at a second distance and capture a second image based on focusing on the object at the second distance, where the second distance is different from the first distance. The multiple image focus module 290 can compress the first image, compress the second image, and create a third image based on a combination of the compressed first image and the compressed second image.

The multiple image focus module 290 can compress the first image by transforming the first image and compress the second image by transforming the second image. Transforming can include transforming the first image and the second image using a discrete cosine transform, a Fourier transform, or any other transforming process. The multiple image focus module 290 can also compress the first image by splitting the first image into a plurality of blocks and compress the second image by splitting the second image into a plurality of blocks and then create the third image based on a combination of the blocks of the first image and the blocks of the second image. The multiple image focus module 290 can compare corresponding blocks between the first image and the second image and create the third image based on selecting preferential blocks between blocks of the first image and blocks of the second image. The multiple image focus module 290 can add components within each block of the first image with other components within the respective block to obtain a plurality of block sums, store the block sums in an array for the first image, add components within each block of the second image with other components within the respective block to obtain a block sum, and store the block sums in an array for the second image. For example, multiple image focus module 290 can add the absolute value of the components within each block. The multiple image focus module 290 can then create the third image based on selecting preferential blocks between blocks of the first image and blocks of the second image based on comparing block sums of the first image with block sums of the second image. The multiple image focus module 290 can also subtract the block sums of the first image from the block sums of the second image and create the third image by replacing the blocks in the second image with the blocks from the first image when the subtraction of the block sums gives a negative value. The multiple image focus module 290 can also align blocks of the first image with blocks in the second image and create a third image by replacing selected blocks in the second image with respective blocks from the first image when the block sum of the respective block of the first image is higher than the block sum of the respective block of the second image. The display 240 can display the third image.

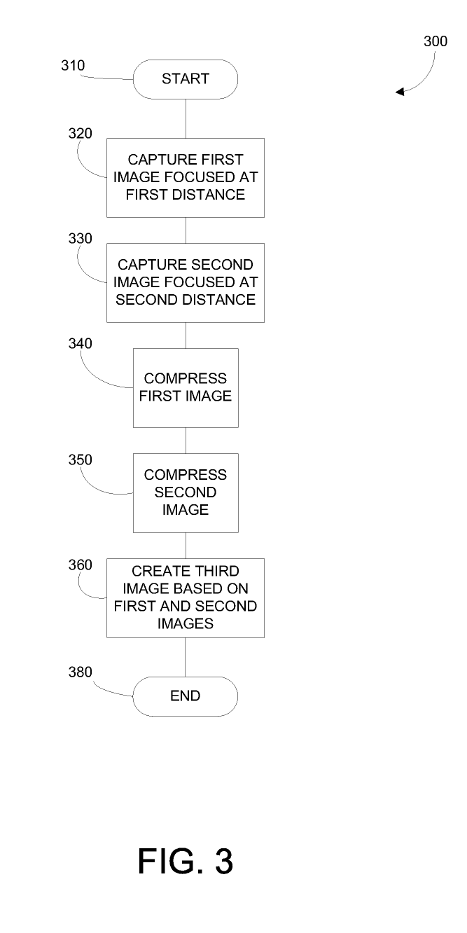

FIG. 3 is an exemplary flowchart 300 illustrating the operation of the apparatus 200 according to another possible embodiment. In step 310, the flowchart begins. In step 320, the apparatus 200 can focus on an object at a first distance and capture a first image based on focusing on the object at the first distance. In step 330, the apparatus 200 can focus on an object at a second distance, where the second distance is different from the first distance, and capture a second image based on focusing on the object at the second distance. In step 340, the apparatus 200 can compress the first image. In step 350, the apparatus 200 can compress the second image. In step 360, the apparatus 200 can create a third image based on a combination of the compressed first image and the compressed second image.

Compressing the first image can include transforming the first image and compressing the second image can include transforming the second image. For example, transformation can be color space transformation into Y, C_{b} and Cᵣ components, can be frequency domain transformation, can be discrete cosine transformation, or can be any other transformation useful for image processing. Compressing the first image can also include splitting the first image into a plurality of blocks and compressing the second image can include splitting the second image into a plurality of blocks. Then, the apparatus 200 can create the third image based on a combination of the blocks of the first image and the blocks of the second image.

When creating the third image, the apparatus 200 can compare corresponding blocks from the first image and the second image and then create the third image based on selecting preferential blocks between blocks of the first image and blocks of the second image. When creating the third image, the apparatus 200 can also add components within each block of the first image with other components within the respective block to obtain a plurality of block sums, store the block sums in an array for the first image, add components within each block of the second image with other components within the respective block to obtain a block sum, and store the block sums in an array for the second image. For example, the apparatus 200 can also add the absolute value of the components within each block. The third image can then be created based on selecting preferential blocks between blocks of the first image and blocks of the second image based on comparing block sums of the first image with block sums of the second image. The block sum may be the sum of the alternative component (AC) coefficients of a block. When creating the third image, the apparatus 200 can also subtract the block sums of the first image from the block sums of the second image and then create the third image by replacing the blocks in the second image with the blocks from the first image when the subtraction of the block sums gives a negative value. The apparatus 200 can further create the third image by aligning blocks of the first image with blocks in the second image and creating the third image by replacing selected blocks in the second image with respective blocks from the first image when the block sum of the respective block of the first image is higher than the block sum of the respective block of the second image. For example, a block, such as a Minimum Coded Unit (MCU), of one image will be used if it has a higher AC sum than a corresponding block of the other image. When creating the third image, the apparatus 200 can then output the third image by displaying the third image or transferring the third image. For example, the apparatus 200 can transfer the third image to a removable memory card, which can be removed and used in another device. The apparatus 200 may also transfer the third image by using a data cable or a wireless signal to send the image to another device. In step 350, the flowchart 300 ends or the apparatus 200 may continue to process additional images.

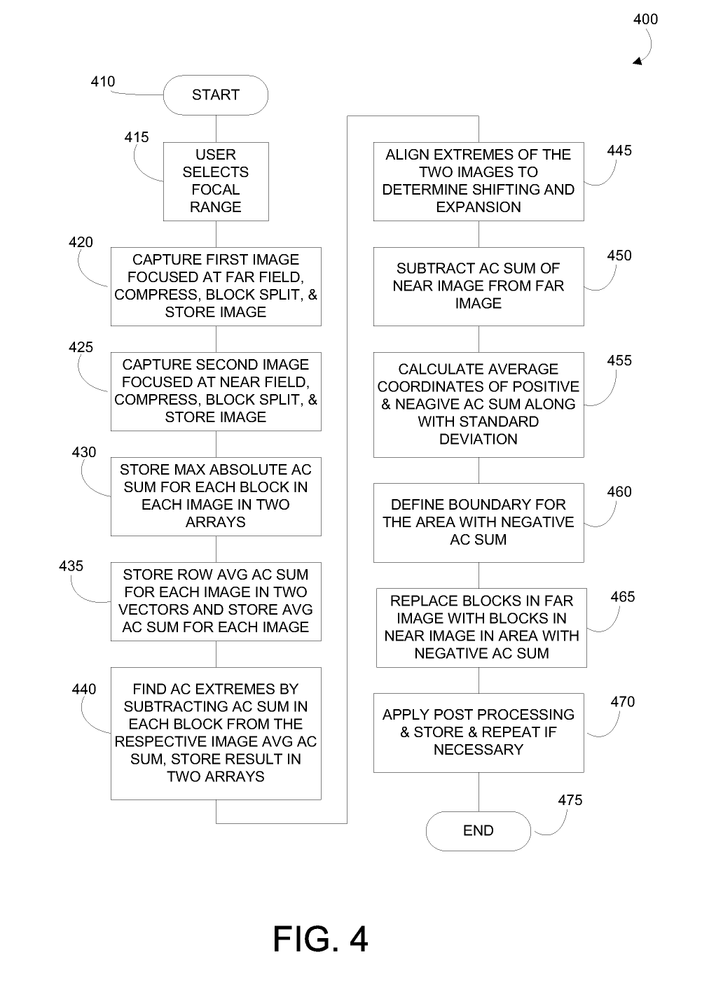

FIG. 4 is an exemplary flowchart illustrating the operation of the apparatus 200 according to another possible embodiment. In step 410, the flowchart 400 begins. In step 415, a user of the apparatus 200 may select a focal range for the camera module 285. For example, the user can select from a near field of 0-20 cm, a medium range of 20-80 cm, and a far field of over 80 cm. The apparatus 200 may also be set to an automatic mode where the apparatus 200 determines the focal range. In step 420, the apparatus 200 can capture the first image, compress the first image and/or block split the first image, and then store the resulting processed first image. In step 425, the apparatus 200 can capture the second image, compress the second image and/or block split the second image and then store the resulting processed second image. For example, the apparatus may perform some steps of JPEG compression on the images, may transform the image into MCU blocks, may transform the image using a discrete cosine transform, may perform run length coding on the image, or may perform other processing on each image.

In step 430, the apparatus 200 can store the maximum absolute AC sum for each block in each image in two arrays, one for each image. For example, each block can be an 8×8 block including a DC coefficient and AC coefficients. The AC coefficients can be added together to get the AC sum for each block and the results can be stored in an array. In step 435, the apparatus 200 can store the row average AC sum for each image in two vectors and store the overall average AC sum for each image. Alternately, the column average AC sum can be stored. In step 440, the apparatus 200 can find the AC extremes by subtracting the AC sum in each block from the respective image overall average AC sum and the result can be stored in two arrays. In step 445, the apparatus 200 can align the extremes of the two images to determine shifting and expansion factors.

Next, the apparatus 200 can compare the blocks of the images to determine which blocks are in better focus. One example is given by subtracting blocks for the comparison. Alternately, other methods may be used for the comparison, such as merely determining which blocks have the larger AC sum to determine which have better focus. According to this example, in step 450, the apparatus 200 can subtract the AC sum of the near image from the far image. In step 455, the apparatus 200 can calculate the average coordinates of the positive and negative AC sums along with the standard deviation in four directions. This step can help align the images in case objects have moved between times when the images were captured or if the user shifted the camera when taking the images. Multiple coordinates may be used beyond the average coordinates of positive and negative AC sums if many objects are present at different distances in the images. In step 460, the apparatus 200 can define the boundary for the area with the negative AC sum. This step can figure out the boundary of the objects to later smooth the boundary using processing. In step 465, the apparatus 200 can replace the blocks in the far image with the blocks in the near image in the area with the negative AC sum. This step replaces the less focused blocks with the better focused blocks which results in all of the objects in the final image being in better focus than only selected objects in each original image. In step 470, post processing can be performed and the final image can be stored in the memory 270 or the process can be repeated if additional images are to be combined. In step 475, the flowchart ends.

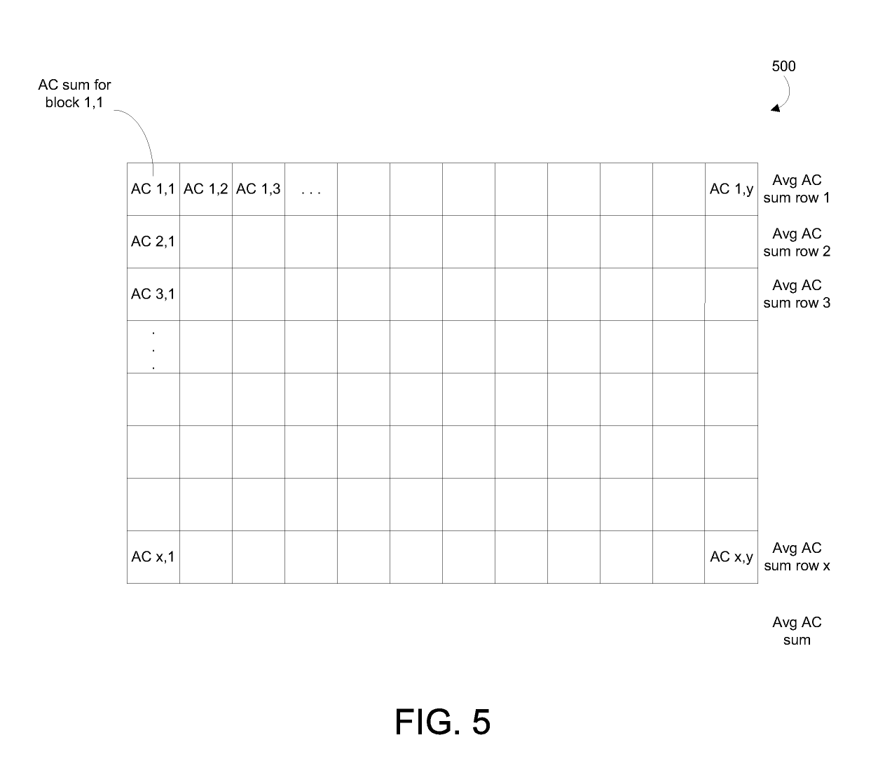

FIG. 5 is an exemplary illustration of an array 500 according to one possible embodiment. Each element in the array 500 can represent the AC sum for the respective block in an image that has x by y blocks. For example, the AC sum at location l,l can represent the sum of the coefficients of a block located at the first row and the first column of an image. The average AC sum for each row can be obtained and the row averages can be averaged to get the overall average AC sum for the image.

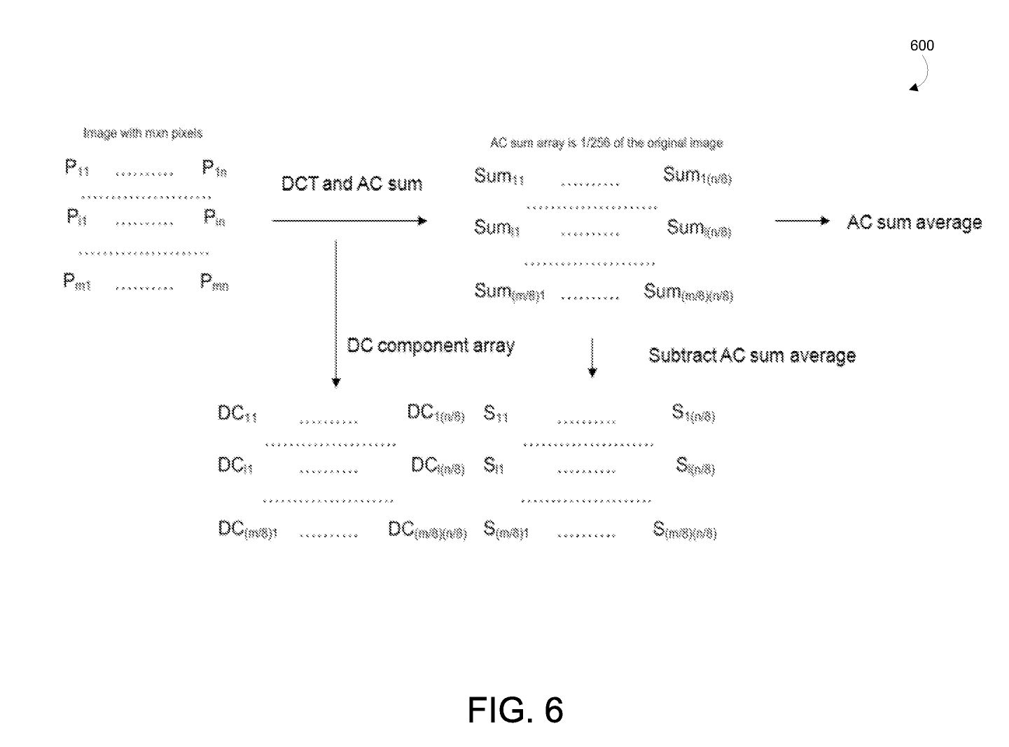

FIG. 6 is an exemplary illustration of an algorithm used by the apparatus 200 according to one possible embodiment. The algorithm illustrates the operation of corresponding steps of the flowcharts 300 and 400. In operation, a DCT operation can be performed on an image of m×n pixels. A DC component array (DC) can be extracted from blocks of the image. Also, an AC sum array (Sum) can be determined by adding up the AC coefficients of each block and placing it in an array. For example, a JPEG process can divide an original image array into 8×8 blocks as Y component data units. The AC sum array for the Y component can have a size of 1/64 of the original image array. Because each block, such as a MCU, can have 4 Y component Data Unit (DU) blocks, one Cᵣ block (8×8) and one C_{b} block (8×8), the AC sum arrays for C_{b} and Cᵣ components can be 1/256 of the original image array. To elaborate on the example, the array size of the Y AC component summation can be 1/64 of the original image size, while the arrays of C_{b} & Cᵣ AC component summation can be 1/256 of the original image size because JPEG MCU can have 4 8×8 Y component DU's, one 8×8 C_{b} DU and one 8×8 Cᵣ DU. The average AC sum can be determined from the AC sum array and it can be subtracted from each element of the array to give another array (S), where each array is used in the corresponding steps described in the flowcharts 300 and 400. After the average AC sum is subtracted, convolution (I) can be used to align the two images according to:

I=Σ[(S_{image1}(i,j)S_{image2}(i−k,j−l)]

Where i and j are the respective index locations of the elements in the arrays. When I is maximized, k and l can be the required shift in i and j to align the two images. For example, typically k and l can be within +/−5% of the i and j values.

The method and apparatus of this disclosure can improve a camera's focus range, which can be useful on small devices that do not have large camera lenses. It can be used with existing auto macro and auto focus solutions. If images are combined in the compressed or frequency domain, the memory requirement can be reduced by 90%. As an example, for a three megapixel image, the saving can be 16 Mbytes. Furthermore, the present disclosure allows for lower power consumption due to less processing and less memory traffic.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method comprising:
focusing on a first object at a first distance;
capturing a first image based on focusing on the first object at the first distance;
focusing on a second object at a second distance, where the second distance is different from the first distance;
capturing a second image based on focusing on the second object at the second distance;
compressing the first image;
compressing the second image; and
creating a third image based on a combination of the compressed first image and the compressed second image.

2. The method according to claim 1,
wherein compressing the first image comprises transforming the first image, and
wherein compressing the second image comprises transforming the second image.

3. The method according to claim 2, wherein transforming comprises transforming the first image and the second image using a discrete cosine transform.

4. The method according to claim 1,
wherein compressing the first image comprises splitting the first image into a plurality of blocks; and
wherein compressing the second image comprises splitting the second image into a plurality of blocks; and
wherein creating a third image comprises creating a third image based on a combination of the blocks of the first image and the blocks of the second image.

5. The method according to claim 4, further comprising:
comparing corresponding blocks from the first image and the second image,
wherein creating comprises creating a third image based on selecting preferential blocks between blocks of the first image and blocks of the second image.

6. The method according to claim 4, further comprising:
adding components within each block of the first image with other components within the respective block to obtain a plurality of block sums;
storing the block sums in an array for the first image;
adding components within each block of the second image with other components within the respective block to obtain a block sum; and
storing the block sums in an array for the second image,
wherein creating a third image comprises creating a third image based on selecting preferential blocks between blocks of the first image and blocks of the second image based on comparing block sums of the first image with block sums of the second image.

7. The method according to claim 6, further comprising:
subtracting the block sums of the first image from the block sums of the second image,
wherein creating a third image comprises creating a third image by replacing the blocks in the second image with the blocks from the first image when the subtraction of the block sums gives a negative value.

8. The method according to claim 6, further comprising:
aligning blocks of the first image with blocks in the second image; and
wherein creating a third image comprises creating a third image by replacing selected blocks in the second image with respective blocks from the first image when the block sum of the respective block of the first image is higher than the block sum of the respective block of the second image.

9. The method according to claim 1, wherein all steps are performed within a digital camera.

10. The method according to claim 1, further comprising outputting the third image by one selected from displaying the third image and transferring the third image.

11. An apparatus comprising:
a controller configured to control the operations of the apparatus;
a memory coupled to the controller;
a camera module coupled to the controller, the camera module configured to focus on a first object at a first distance and capture a first image based on focusing on the first object at the first distance, the camera module also configured to focus on a second object at a second distance and capture a second image based on focusing on the second object at the second distance, where the second distance is different from the first distance; and
a multiple image focus module coupled to the controller, the multiple image focus module configured to compress the first image, compress the second image, and create a third image based on a combination of the compressed first image and the compressed second image.

12. The apparatus according to claim 11, wherein the multiple image focus module is configured to compress the first image by transforming the first image and compress the second image by transforming the second image.

13. The apparatus according to claim 12, wherein transforming comprises transforming the first image and the second image using a discrete cosine transform.

14. The apparatus according to claim 11,
wherein the multiple image focus module is configured to compress the first image by splitting the first image into a plurality of blocks and compress the second image by splitting the second image into a plurality of blocks, and
wherein the multiple image focus module is configured to create the third image based on a combination of the blocks of the first image and the blocks of the second image.

15. The apparatus according to claim 14, wherein the multiple image focus module is configured to compare corresponding blocks between the first image and the second image and create the third image based on selecting preferential blocks between blocks of the first image and blocks of the second image.

16. The apparatus according to claim 14,
wherein the multiple image focus module is configured to add components within each block of the first image with other components within the respective block to obtain a plurality of block sums, store the block sums in an array for the first image, add components within each block of the second image with other components within the respective block to obtain a block sum, and store the block sums in an array for the second image, and
wherein multiple image focus module is configured to create the third image based on selecting preferential blocks between blocks of the first image and blocks of the second image based on comparing block sums of the first image with block sums of the second image.

17. The apparatus according to claim 16,
wherein the multiple image focus module is configured to subtract the block sums of the first image from the block sums of the second image, and
wherein the multiple image focus module is configured to create the third image by replacing the blocks in the second image with the blocks from the first image when the subtraction of the block sums gives a negative value.

18. The apparatus according to claim 16,
wherein the multiple image focus module is configured to align blocks of the first image with blocks in the second image, and
wherein the multiple image focus module is configured to creating a third image by replacing selected blocks in the second image with respective blocks from the first image when the block sum of the respective block of the first image is higher than the block sum of the respective block of the second image.

19. The apparatus according to claim 11, further comprising a display configured to display the third image.

20. A method comprising:
focusing on a first object at a first distance;
capturing a first image based on focusing on the first object at the first distance;
focusing on a second object at a second distance, where the second distance is different from the first distance;
capturing a second image based on focusing on the second object at the second distance;
splitting the first image into first blocks including components;
splitting the second image into second blocks including components;
storing the sum of the components of each of the first blocks into a first array;
storing the sum of the components of each of the second blocks into a second array;
comparing elements of the first array with elements of the second array; and
creating a third image based on combining the blocks of the first image with the blocks of the second image based on comparing the elements of the first array with the elements of the second array.
